(19) United States
(12) Patent Application Publication
(10) Pub. No.: US 2007/0054565 A1
(43) Pub. Date: Mar. 8, 2007

(54) Electric contract crimping method and contact obtained according to said method

(76) Inventors: Thierry Courtin, Le May Sur Evre (FR); El Mostafa Zindine, Le Mans (FR); Flavio Fantini, Puteaux (FR)

Correspondence Address: HARRINGTON & SMITH, LLP, 4 RESEARCH DRIVE, SHELTON, CT, 06484-6212, US

(21) Appl. No.: 10/566,661

(22) PCT Filed: Mar. 15, 2004
(86) PCT No.: PCT/FR04/00631

§ 371 Date: Jan. 31, 2006

(30) Foreign Application Priority Data
Aug. 19, 2003 (FR) 03/10011

(51) Int. Cl. H01R 13/11

(52) U.S. Cl. 439/851

(57) ABSTRACT

The invention relates to an electric contact crimping method carried out on an electric wire, said contact including a crimping section provided with a barrel for receiving the electric wire, said barrel including a part which is used to clasp the wire by deformation. The method includes a first crimping step carried out at a first crimping height by folding a first surface of the crimping section on the wire by means of a crimping tool including a stamping element and an anvil and a second crimping step carried out at a second crimping height which is lower than the first, in a localized area of the crimping section. The invention also relates to a contact obtained according to said method.

The present invention concerns an electric contact crimping method and the contact obtained by this method.

It is known how to create an electric contact between an electric wire, particularly a multistranded wire, and a metal contact element by a crimping operation for which wings cut out of the metal contact element are bent around the stripped electric wire by means of a crimping tool of the stamp-anvil type. This technique is applied to contacts made from a metal blank that has been cut and bent.

Document U.S. Pat. No. 5,561,267 concerns, for example, a contact to be crimped comprising wings of different size permitting covering one crimping wing onto another and a crimping method with a specially designed stamp-anvil tool.

The crimped contacts encounter problems of reliability in low current and low voltage applications and more particularly, microcracks appear over time. It has been shown that crimping can lose its efficacy due to an elastic spring back phenomenon of the crimping wings which causes a reduction of the contact pressure between the wings and the strands of crimped wire and can lead to increases or instabilities of contact resistance, or even losses of electrical contact.

Document U.S. Pat. No. 5,025,554, for its part, concerns a crimping to which soldering paste has been added in order to improve electrical conduction. The problem of such a combination is the difficulty of placing a small quantity of the soldering paste at specific sites in an automated crimping process in a production line of automobile wiring and at the cadences associated therewith.

The present invention seeks to improve crimped electrical contacts and to solve the problem of elastic spring back in order to conserve a high contact pressure throughout the life of the contact.

More particularly, the present invention concerns a method for crimping the electric contact onto an electric wire, the contact having a crimping section provided with a barrel for receiving the electrical wire, the barrel having a part designed to crimp the wire by deformation, the method comprising a first crimping step at a first crimping height by folding a first surface of the crimping section over the wire by means of a crimping tool comprising a stamping element and an anvil and a second crimping step at a second crimping height, lower than the first, in a localized area of the crimping section.

More particularly, in the case where the crimping section has an open barrel for receiving the electric wire and crimping wings extending beyond the barrel and designed to crimp the wire, the first crimping step folds a first surface of the wings over the wire at said first height and the second crimping step folds a localized zone of the wings at said second height, lower than the first.

In a particular embodiment, the second crimping can be carried out over two disjoint zones of said wings. More particularly, the second crimping can notably be carried out over end zones of the wings.

In an alternative embodiment, the second crimping can be carried out over a central zone of said wings.

Advantageously, the first crimping step can be conducted over the entire surface of the wings so as to close the wings onto the wire.

According to a preferential embodiment of the invention, the second crimping step is conducted over a part of the wing surface that has undergone the first crimping step.

The method can notably be one in which the crimping tool has a common anvil and separable stamping element parts. The barrel in particular can be deformed during the first crimping step and keep its form during the second crimping step.

The invention also concerns an electric contact element having a crimping section provided with an open barrel equipped with wings for crimping onto an electric wire, the crimping section being crimped onto the wire by the method described previously such that, after crimping, the crimping section has three successive zones for crushing the wings onto the wire, two of the three zones being of reduced thickness with regard to the third zone so that the wire exerts an elastic force on the wings at the level of the third zone. Alternatively, one of the three zones is of reduced thickness with regard to the two other zones so that the wire exerts an elastic force on the wings at the level of the other two zones.

Other characteristics and advantages will be better understood upon reading the description that follows of one particular embodiment of the invention given by way of non-limiting example and in reference to the figures, which show

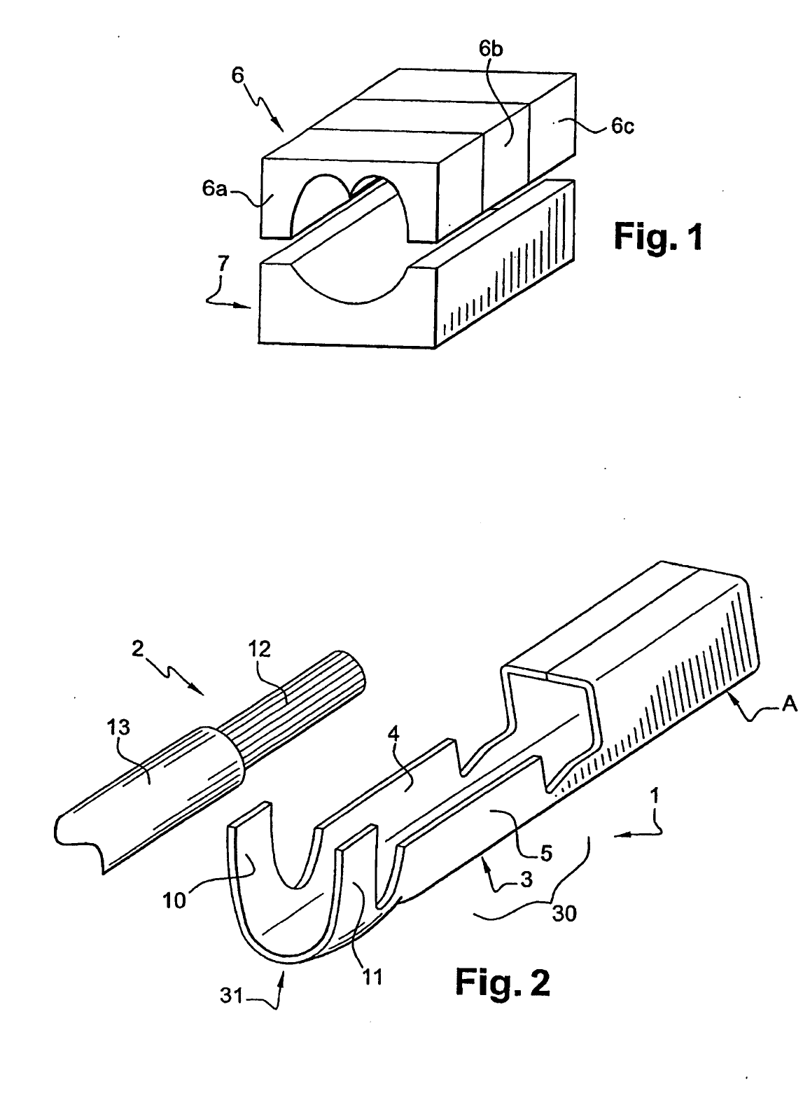

In FIG. 1: A crimping tool according to one aspect of the invention;

In FIG. 2: An electric contact element and a wire to be crimped according to the method of the invention;

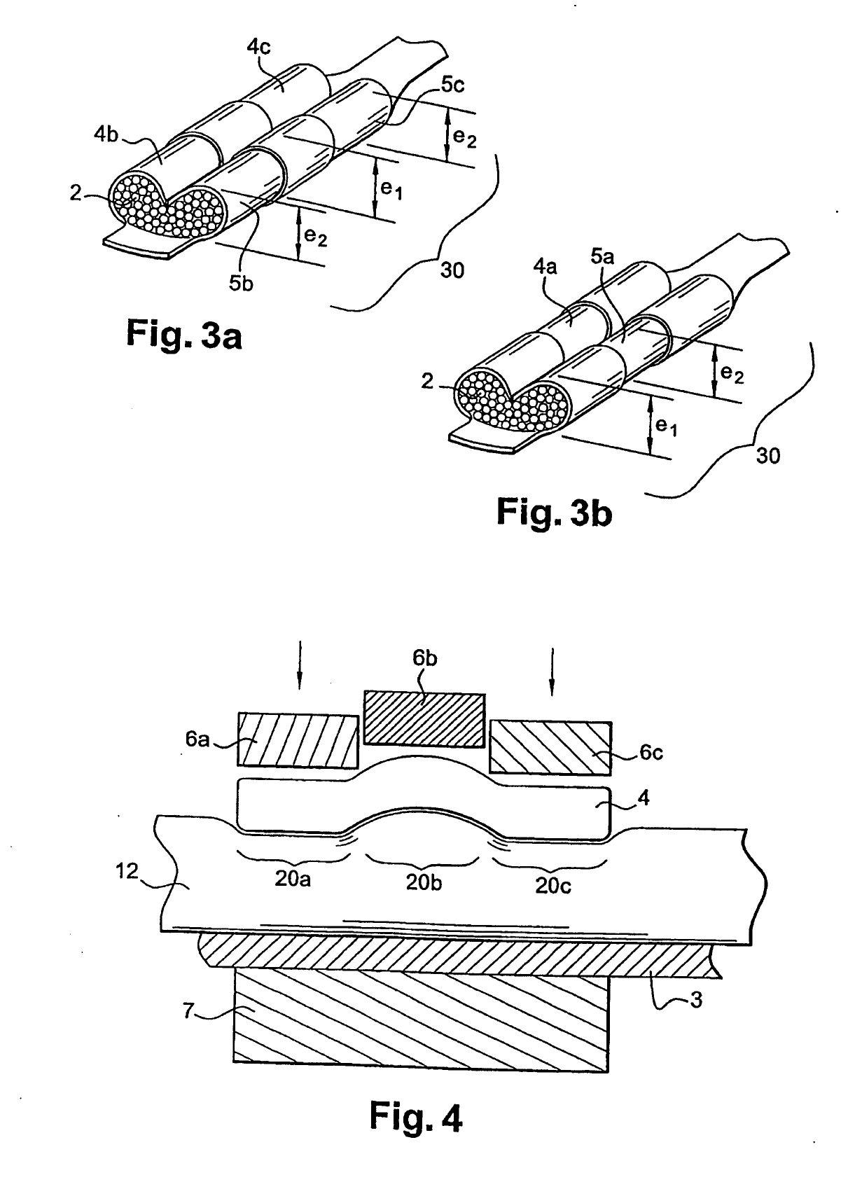

In FIGS. 3a and 3b: A contact crimped by means of the method of the invention;

In FIG. 4: A schematic sectional view of a crimping of the electric wire obtained by the method according to the invention;

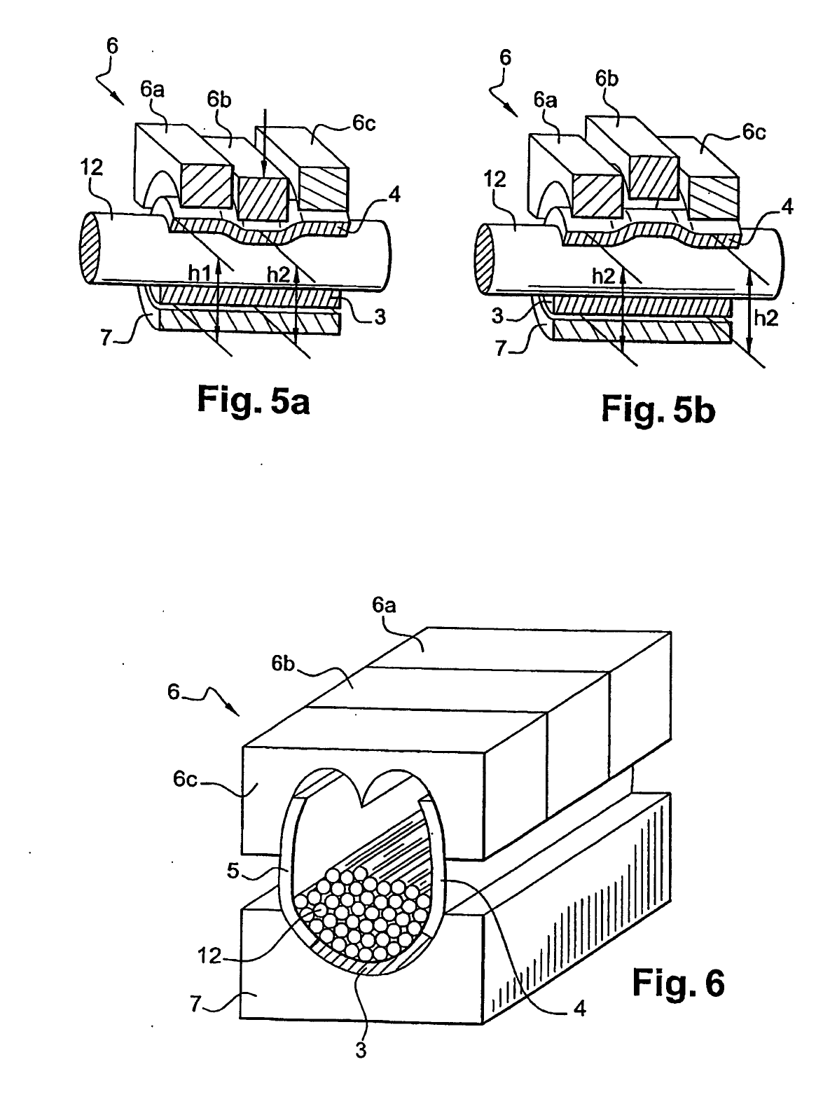

In FIGS. 5a and 5b: Two versions of the second crimping step of the method according to the invention;

In FIG. 6: A schematic representation of the first crimping step of the method according to the invention.

According to the example of application shown in FIG. 2, crimping is conducted on electric contacts with an open barrel. Such contacts comprise a front part A, notably for coupling to a traditionally-known complementary contact, and having in an intermediate part, for coupling by crimping, a crimping section 30 provided with an open barrel 3 equipped with wings 4, 5 for crimping onto a stripped part 12 of an electric wire 2, the crimping section being designed to be crimped onto the wire to create an electric contact between wire 2 and contact element 1.

According to the example, contact 1 has a terminal section 31 forming a force-absorbing zone provided with wings 10, 11 designed to be closed onto insulation 13 of wire 2.

Front part A of the contact element can be of any type and can possibly even be made up of a second section for coupling by crimping in order to create a splice, for example.

Such contact elements are made by cutting and folding a metal strip of small thickness of the order of 0.2 mm to several millimeters thick.

Due to the need for these contacts to have a good rigidity and, in the case of contacts with contact spring blades, a good elasticity, the material used is not very ductile and is subject to elastic spring back during folding or shaping operations.

It has been shown that this elastic spring back exists at the level of wings 4, 5 for crimping and even if the variations in dimensions are only of the order of several microns, this elastic spring back can cause intermittent loss of contact between the strands and the contact element, particularly in low-current and low-voltage applications such as self-diagnostic procedures for elements mounted on automobiles.

Moreover, the wire, generally copper-based, has a small elastic spring back capacity, and is notably less than that of alloys such as a copper-beryllium alloy often employed for contact elements.

The invention intends to modify the mechanical crimping behavior in order to utilize the physical phenomenon of elastic spring back in a favorable sense over a particular contact zone.

To do this, the method of crimping a crimping section of an electric contact element 1 onto an electric wire 2 according to the invention comprises a first crimping step for crimping section 30 onto stripped part 12 of the wire at a first height h1 by folding wings 4, 5 onto wire 2 by means of a crimping tool comprising a stamping element 6 and an anvil 7. For this first step, the beginning of which is described in FIG. 6, stamping element 6, made up of three parts 6a, 6b, 6c according to the example, is applied with its three parts over all of wings 4 and 5 and the anvil is applied under barrel 3, wings 4 and 5 being continuous wings.

Crimping height h1 is obtained as a function of the dimensions of the contact and of the wire by classical crimping such as is obtained with a minimal amount of compression of the order of 5% so as to close the wings onto the wire. This first crimping step is carried out over a major part of the surface of wings 4, 5 or even all of these wings by stamping element 6 and over a major part or even all of barrel 3 by anvil 7.

The method comprises a second step or crimping operation, this operation being conducted at a second height h2, lower than the first, in a localized zone of the wings. This step is conducted in such a way that an amount of compression greater than 15% and typically of the order of 25 to 30% is obtained under the crimping tool. This second step is shown schematically in FIGS. 4 and 5b representing a first embodiment for which only parts 6a, 6c of stamping element 6 are applied on ends 4a, 4c, 5a, 5c of the wings, part 6b remaining in a set-back position and not coming into contact with the wings; and, in FIG. 5a, in a second embodiment for which only stamping part element 6b is applied on parts 4b and 5b of the wings, stamping parts 6a and 6c remaining set back and not coming into contact with the wings.

In both embodiments, the second crimping step is carried out over a part of the wing surface that has undergone the first crimping step.

These two embodiments of the second crimping lead to two variants for the contact, one in which longitudinal end zones 4b, 4c, 5b, 5c of the wings as shown in FIG. 3a are more crushed, so that the corresponding height h2 for the contact results in a thickness e2, and central thickness zone e1 results from crimping height h1 conducted on these wings; in the other variant, the second crimping is carried out over central zone 4a, 5a of these wings as shown in FIG. 3b, so that thicknesses e1 and e2 correspond here also respectively to crimping heights h1 and h2.

According to the example of FIG. 3a, the crimped contact has three successive zones for crushing the wings onto the wire, two of the three zones being of reduced thickness with regard to the third zone so that the wire exerts an elastic force on the wings at the level of the third zone.

According to the example of FIG. 3b, the crimped contact has three successive zones for crushing the wings onto the wire, one of the three zones being of reduced thickness with regard to the two other zones so that the wire exerts an elastic force on the wings at the level of the other two zones.

The double crimping reverses the elastic spring back to make it play a positive role, i.e., to create a contact pressure between the barrel and the wire strands. According to the method, and as described in FIG. 4, at the end of the second crimping operation, for the embodiment of FIG. 3a, the wire strands locally expand in zone 20b between the two tool parts 6a and 6c creating the second crimping step. Consequently, while for the wing zones under tools 6a and 6c, the elastic spring back of the wings remains greater than that of the wire strands, in zone 20b, it is the wire which deforms the wing by the expanding effect.

The elasticity of the wings thus has a positive effect in this part 20b since it tends to compress the wire, which involves a mechanical contact pressure, and therefore a good electrical conduction even under mechanical or thermal stress.

The crimping tool shown in FIG. 1 and designed for the method according to the invention, comprises a common anvil 7 and separable stamp element parts 6a, 6b, 6c. Such a tool can function in an automatic press traditionally used by means of a separate control for the stamping element parts.

It is possible, of course, to conduct the crimping operations on two separate stations, a first station having a first stamping element that conducts the first crimping and a second station having a stamping element designed to conduct the second crimping onto a particular contact zone. It remains that the embodiment in which stamping element 6 is divided into mobile stamping element parts that can be activated separately permits conserving a perfect alignment of the contact element with the stamping element parts and successively conducting the two operations on the same press.

The purpose of the common anvil is that barrel 3 is deformed during the first crimping step and keeps its form during the second crimping step. The barrel thus keeps a good mechanical rigidity and a good resistance to mechanical stress in cases of traction on the wire.

Such a method is applicable to contacts to be crimped with an open barrel for cut-out and folded electric contacts, but also to closed-barrel contacts such as cut-out and rolled contacts based on sheet metal.

It should be noted that according to the invention in which the stamping element is divided into mobile stamping element parts that can be activated separately, the first crimping step can be effected by means of only stamping element part 6b (for a final result of the second step of the type shown in FIG. 3a) or by means of only parts 6a and 6c of this stamping element (for a final result of the second step of the type shown in FIG. 3b), this means that parts 6a and 6c, and respectively, part 6b, remain(s) in a high position during this first step without coming to be pressed forcefully onto wings 4 and 5 of the barrel positioned on the anvil. Wings 4 and 5 nevertheless will undergo a more-or-less marked folding/crimping operation over all or a very significant part of their length beyond the sole zone(s) of the wing(s) onto which part 6b, or respectively, parts 6a/6c of the stamping element come to be applied. In this case, the first crimping height defines the crimping height on the central zone of the wings, or, the crimping height on the end zones of the wings. The second crimping step which follows the first step is thus conducted by means of parts 6a, 6c, or, respectively, part 6b, according to the invention, stamping element part 6b, or, respectively, parts 6a and 6c of this stamping part, remaining in an end-of-course position in the first step to keep the barrel in the form which it has acquired from the first step. Thus, the first crimping step crimps at least one first zone of each wing 4 and 5 of the barrel at a first crimping height, by folding the wings in a more-or-less marked manner over a surface extending beyond said at least one first zone, and the second crimping step crimps at the second crimping height in at least one second zone of each wing 4 and 5, called the localized region of the crimping section, complementary to said at least one first zone.

1. A method for crimping electric contact onto an electric wire, the contact having a crimping section provided with a barrel for receiving electric wire, the barrel comprising a part designed to clasp the wire by deformation, characterized in that it comprises a first crimping step at a first crimping height by folding a first surface of the crimping section over wire by means of a crimping tool comprising a stamping element and an anvil and a second crimping step at a second crimping height, lower than the first, in a localized region of the crimping section.

2. The method for crimping electric contact according to claim 1, further characterized in that crimping section has an open barrel for receiving electric wire and crimping wings, those wings extending beyond the barrel and being designed to clasp the wire, and in that the first crimping step folds a first surface of wings at said first height onto wire and the second crimping step folds a localized region of the wings at a second crimping height, lower than the first.

3. The method according to claim 2, further characterized in that the second crimping is conducted over two disjoint zones of the wings.

4. The method according to claim 3, further characterized in that the second crimping is conducted over two end zones of the wings.

5. The method according to claim 2, further characterized in that the second crimping is conducted on a central zone of the wings.

6. The method according to claim 1, further characterized in that the first crimping step is conducted over the entire surface of wings.

7. The method according to claim 6, further characterized in that the second crimping step is conducted over a part of the surface of the wings having undergone the first crimping step.

8. The method according to claim 1, further characterized in that the crimping tool has a common anvil and separable stamping element parts.

9. The method according to claim 1, further characterized in that barrel is deformed during the first crimping step and keeps its form during the second crimping step.

10. An electric contact element comprising a crimping section provided with an open barrel equipped with wings for crimping onto an electric wire, said crimping section being crimped onto the wire by a method according to of claim 1, characterized in that after crimping, crimping section has three successive zones for crushing the wings onto the wire, two of the three zones being of reduced thickness with regard to the third zone so that the wire exerts an elastic force on the wings at the level of said third zone.

11. An electric contact element comprising a crimping section provided with an open barrel equipped with wings for crimping onto an electric wire, the crimping section being crimped onto the wire by a method according to claim 1, characterized in that after crimping, crimping section has three successive zones for crushing the wings onto the wire, one of the three zones being of reduced thickness with regard to the other two zones so that the wire exerts an elastic force on the wings at the level of said other two zones.
